(19) United States
(12) Patent Application Publication
(10) Pub. No.: US 2017/0085110 A1
(43) Pub. Date: Mar. 23, 2017

(54) Table-top Tripod with Charging Function

(71) Applicant: Zhongshan Nikow Precision Industrial Co., LTD., Zhongshan City (CN)

(72) Inventor: Zhihua LI, Zhongshan City (CN)

(21) Appl. No.: 14/862,777

(22) Filed: Sep. 23, 2015

(51) Int. Cl. H02J 7/00

(52) U.S. Cl. CPC H02J 7/0054; H02J 7/0042; H02J 2007/0062

(57) ABSTRACT

The present invention discloses a table-top tripod with charging function which comprises a support body, wherein three supporting legs capable of opening and closing are hinged to a lower part of the support body, and at least one supporting leg is internally provided with a power supply that may supply power to external electronic equipment. As the supporting leg of the table-top tripod is internally provided with a power supply capable of supplying power to the electronic equipment, when the table-top tripod is used outdoors for supporting the electronic equipment, if the electronic equipment runs out of power, the user may use the table- top tripod to supply power to the electronic equipment, thereby prolonging the service time of the electronic equipment and well satisfying the user's requirements.

### FIELD OF THE INVENTION

The present invention relates to photographic apparatus, in particular to a table-top tripod with charging function.

### BACKGROUND OF THE INVENTION

It is well known that as the tripod may be used for supporting electronic equipment to leave a user's hands free, the user is relieved from having to hold the electronic equipment for a long time, thereby greatly alleviating the burden on the user, so that the tripod is increasingly preferred.

Although an existing tripod may be used for supporting electronic equipment to alleviate the user's burden, when used outdoors, the tripod may not be able to power the electronic equipment if the electronic equipment runs out of power and fails to work properly, thus the existing tripod is sole in function and cannot well meet the user's demands.

### SUMMARY OF THE INVENTION

In order to solve the above problems, the present invention aims to provide a table-top tripod which is simple in structure and may support the electronic equipment while supplying power to the electronic equipment.

The technical scheme that the invention adopts to solve its technical problems is as follows:

A table-top tripod with charging function comprises a support body, wherein three supporting legs capable of opening and closing are hinged to a lower part of the support body, and at least one supporting leg is internally provided with a power supply that may supply power to external electronic equipment.

As an improvement to the above technical scheme, the power supply is a storage battery which is connected with a USB interface for supplying power to the external electronic equipment and a charging interface for charging the storage battery.

As a further improvement to the above technical scheme, the USB interface and the charging interface are arranged in a side wall of the supporting leg.

In the present invention, the power supply is further connected with a display device for displaying electric quantity of the power supply.

Preferably, the display device is an electric quantity indicator light or a display screen.

Further preferably, an upper part of the support body is removably connected with a tether.

In a preferred embodiment of the present invention, the tether is fixedly connected to an end cover which is connected to the upper part of the support body through thread.

Further, each of the three supporting legs is provided with a power supply.

The invention has the following advantages that: as the supporting leg of the table-top tripod is internally provided with a power supply capable of supplying power to the electronic equipment, when the table-top tripod is used outdoors for supporting the electronic equipment, if the electronic equipment runs out of power, the user may use the table-top tripod to supply power to the electronic equipment, thereby prolonging the service time of the electronic equipment and well satisfying the user's requirements.

### BRIEF DESCRIPTION OF THE DRAWINGS

The present invention will be illustrated in further detail below with reference to the drawings and detailed description of the embodiments.

FIG. 1 is a structural schematic view of appearance of a preferred embodiment of the present invention;

FIG. 2 is a partially exploded schematic view of a preferred embodiment of the present invention;

FIG. 3 is a schematic view of a certain supporting leg being in an open state of a preferred embodiment of the present invention; and

FIG. 4 is an enlarged schematic view of A in FIG. 3.

### DETAILED DESCRIPTION OF THE EMBODIMENTS

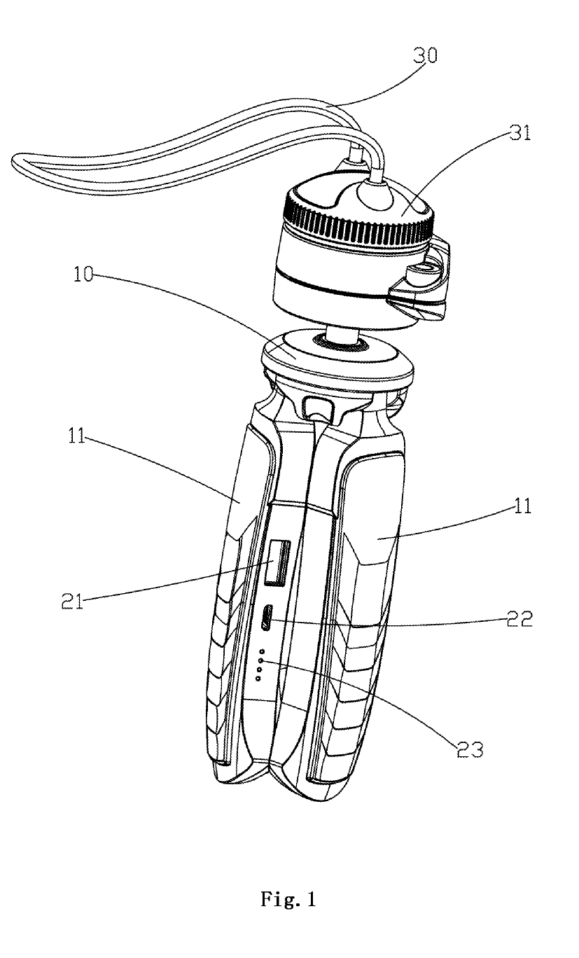

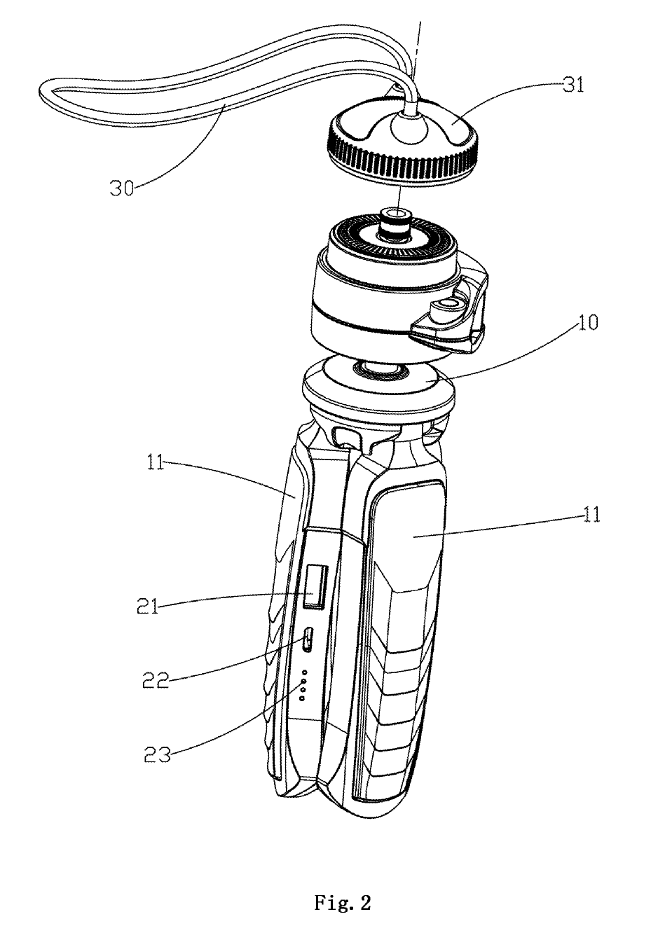

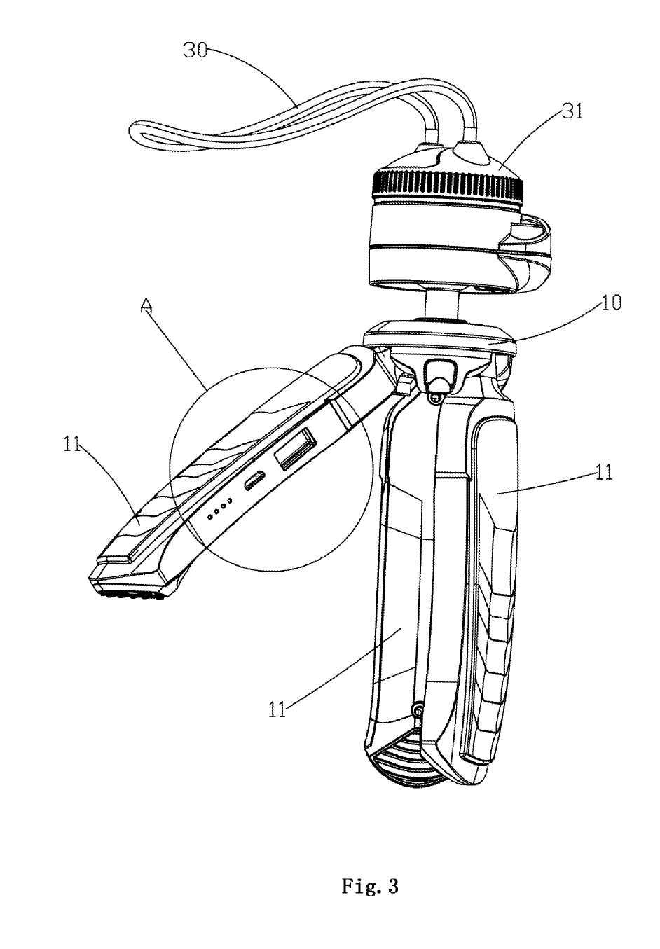

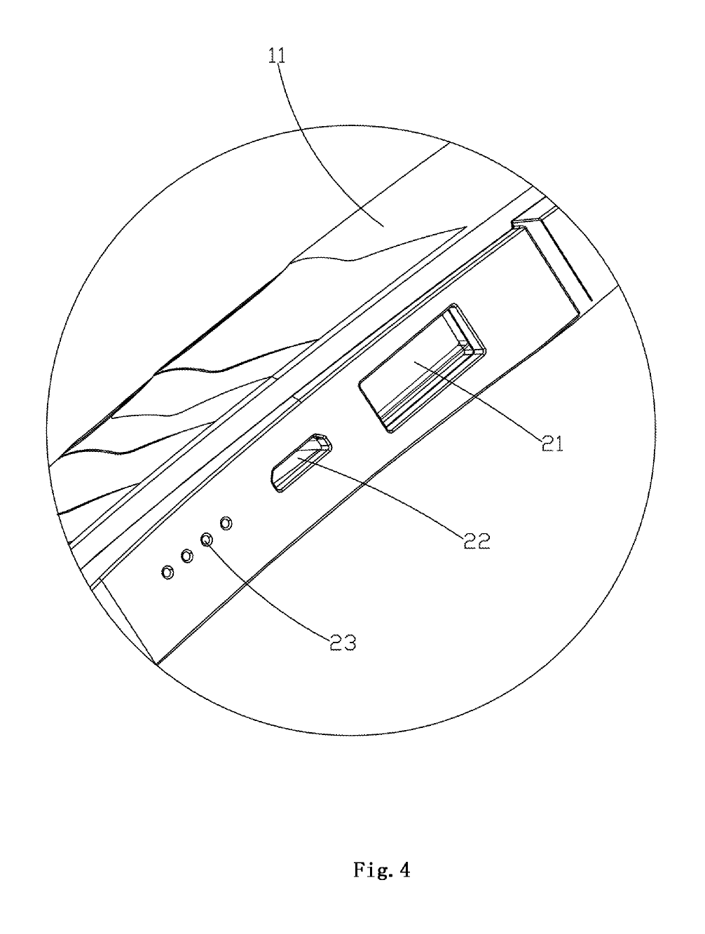

Referring to FIGS. 1 to 4, a table-top tripod with charging function comprises a support body 10, wherein three supporting legs 11 capable of opening and closing are hinged to a lower part of the support body 10, and at least one supporting leg 11 is internally provided with a power supply that may supply power to external electronic equipment. It is preferred herein that three supporting legs are each provided with a power supply, and of course two of the three supporting legs 11 may be provided with power supplies.

In order to supply power to the external electronic equipment easily while allowing the power supply to be used repeatedly, it is preferred in the present invention that the power supply is a storage battery which is connected with a USB interface 21 for supplying power to external electronic equipment and a charging interface 22 for charging the battery charge. Of course, the above-mentioned power supply may also be a dry battery, except that the power supply may not be repeatedly used for supplying power to the electronic equipment.

In order to make the appearance of the table-top tripod of the present invention more aesthetically appealing, it is preferred that the USB interface 21 and the charging interface 22 are arranged in a side wall of the supporting leg 11. Owing to this, when the three supporting legs 11 close, the USB interface 21 and the charging interface 22 will not be exposed, thereby further allowing the overall appearance of the table-top tripod of the present invention to be simpler and more attractive.

Herein, in order to facilitate the user in having a more intuitive understanding of electric quantity of the power supply, it is preferred that the power supply is further connected with a display device 23 for displaying electric quantity of the power supply, and the display device 23 is an electric quantity indicator light or display screen. As a preferred embodiment of the present invention, the display device 23 is an electric quantity indicator light, which contributes to reduction in manufacturing cost of the table-top tripod.

For ease of carrying the table-top tripod by the user, in the present invention, an upper part of the support body 10 is further removably connected with a tether 30. Preferably, the tether 30 is fixedly connected to an end cover 31 which is connected to the upper part of the support body 10 through thread. The user may conveniently tie the table-top tripod to other objects tightly by using the tether 30 so as to carry the table-top tripod conveniently.

The above are merely preferred embodiments of the present invention, all technical schemes should fall within the protection scope of the present invention as long as they achieve the objects of the present invention using substantially the same way.

1. A table-top tripod with charging function, comprising a support body (10), wherein three supporting legs (11) capable of opening and closing are hinged to a lower part of the support body (10), characterized in that: at least one supporting leg (11) is internally provided with a power supply capable of supplying power to external electronic equipment.

2. The table-top tripod with charging function according to claim 1, characterized in that: the power supply is a storage battery which is connected with a USB interface (21) for supplying power to the external electronic equipment and a charging interface (22) for charging the storage battery.

3. The table-top tripod with charging function according to claim 2, characterized in that: the USB interface (21) and the charging interface (22) are arranged in a side wall of the supporting leg (11).

4. The table-top tripod with charging function according to claim 1, characterized in that: the power supply is further connected with a display device (23) for displaying electric quantity of the power supply.

5. The table-top tripod with charging function according to claim 4, characterized in that: the display device (23) is an electric quantity indicator light or a display screen.

6. The table-top tripod with charging function according to claim 1, characterized in that: an upper part of the support body (10) is removably connected with a tether (30).

7. The table-top tripod with charging function according to claim 6, characterized in that: the tether (30) is fixedly connected to an end cover (31) which is connected to the upper part of the support body (10) through thread.

8. The table-top tripod with charging function according to claim 1, characterized in that: each of the three supporting legs (11) is provided with a power supply.
